(19) United States
(12) Patent Application Publication
(10) Pub. No.: US 2017/0249600 A1
(43) Pub. Date: Aug. 31, 2017

(54) AUTOMATED TASK PROCESSING WITH ESCALATION

(71) Applicant: Microsoft Technology Licensing, LLC, Redmond, WA (US)

(72) Inventors: Justin Brooks Cranshaw, Seattle, WA (US); Todd D. Newman, Mercer Island, WA (US); Andrea Ryuta Orimoto, Kirkland, WA (US); Emad M. Elwany, Kirkland, WA (US); Andres Monroy-Hernandez, Seattle, WA (US); Colleen Griffiths Estrada, Bellevue, WA (US); Richard Daniel Marshall, Edmonds, WA (US)

(21) Appl. No.: 15/055,522

(22) Filed: Feb. 26, 2016

(51) Int. Cl. G06Q 10/10; G06Q 10/06

(52) U.S. Cl. CPC G06Q 10/1097; G06Q 10/063112; G06Q 10/06316; G06Q 10/0633

(57) ABSTRACT

Aspects extend to methods, systems, and computer program products for automated task processing with escalation. An overall task to be achieved (e.g., scheduling a meeting) can be broken down into a grouping of (e.g., loosely-coupled) asynchronous sub-tasks. Completing the grouping of sub-tasks completes the overall task. Performance of some sub-tasks can be automated. Other sub-tasks can be escalated for performance by micro workers. When a micro worker is unable to perform a sub-task, the overall task can be escalated to a macro worker. Accordingly, a three tiered approach of automation, micro workers, and macro workers is scalable, cost efficient, and also provides flexibility to accurately handle more complex tasks and sub-tasks.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

One task people often perform with the assistance of a computer, is scheduling meetings. A person can use a computer to schedule their own meetings or can delegate the scheduling of meetings to an assistant. Scheduling meetings is a relatively complex task, because it includes bringing multiple people to consensus. Often such discussions take place over email and require many iterations before an acceptable time is found. Further, even after agreement has been reached, one of the parties may have to reschedule or cancel the meeting.

Scheduling and rescheduling meetings are problems typically solved human assistants. However, hiring a full-time human assistant can be relatively expensive, especially for smaller businesses. As such, some mechanisms for using digital assistances to handle scheduling and rescheduling have been developed.

One mechanism primarily uses machine learning to schedule and reschedule meetings. However, if scheduling cannot be automated, the meeting creating is required to intervene and take over manually. Another mechanism uses shifts of workers to schedule and reschedule meetings for a group of other users. Thus, this other mechanisms still relies primarily on humans and can be also be subject to delays to do workers going off shift.

A further mechanism uses a shared page on which meeting request recipients see a list of times that potentially work for a meeting creator. Recipients interact directly with the shared page on which they see the options and select times that work for them. A computer determines when all invitees have responded and reports either success or failure to reach closure. While having some advantages, this further mechanism still places a significant burden on a meeting initiator. This further mechanism also fails to allow direct negotiations between recipients or multiple iterations of scheduling.

### BRIEF SUMMARY

Examples extend to methods, systems, and computer program products for automated task processing with escalation. A request to perform a task (e.g., scheduling a meeting between multiple participants) is received. A workflow for the task is accessed. The workflow defines a plurality of sub-tasks to be completed to perform the task.

For each sub-task, it is determined if performance of the sub-task can be automated based on: the task, any information obtained through asynchronous communication with the one or more entities associated with the task, and results of previously performed sub-tasks. When the sub-task can be automated, the sub-task is sent to an automated task processing module and results of performing the sub-task from the task processing module is received. When the sub-task cannot be automated, the sub-task is escalated to a worker to be performed. When the sub-task cannot be performed by the worker, the task is escalated to a more skilled worker to be performed.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example architecture that facilitates automated task processing with escalation.

FIG. 2 illustrates a flow chart of an example method for automated task processing with escalation.

### DETAILED DESCRIPTION

Examples extend to methods, systems, and computer program products for automated task processing with escalation. A request to perform a task (e.g., scheduling a meeting between multiple participants) is received. A workflow for the task is accessed. The workflow defines a plurality of sub-tasks to be completed to perform the task.

For each sub-task, it is determined if performance of the sub-task can be automated based on: the task, any information obtained through asynchronous communication with the one or more entities associated with the task, and results of previously performed sub-tasks. When the sub-task can be automated, the sub-task is sent to an automated task processing module and results of performing the sub-task from the task processing module is received. When the sub-task cannot be automated, the sub-task is escalated to a worker to be performed. When the sub-task cannot be performed by the worker, the task is escalated to a more skilled worker to be performed.

Implementations may comprise or utilize a special purpose or general-purpose computer including computer hardware, such as, for example, one or more processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, between automated task formats, micro-task formats, and macro-tasks format.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, automated tasks, micro-tasks, and macro-tasks as well as results generated by performing automated tasks, micro-tasks, and macro-tasks.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, pagers, watches, fitness monitors, eye glasses, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

Aspects of the invention process tasks taking advantage of machine learning and micro tasks with mechanisms to escalate micro tasks to micro workers and escalate tasks to macro workers to appropriately solve problems. An overall task to be achieved (e.g., scheduling a meeting between multiple participants) can be broken down into a grouping of (e.g., loosely-coupled) asynchronous sub-tasks (e.g., micro tasks). Completing the grouping of sub-tasks completes the overall task. Execution of tasks is handled by a workflow engine. The workflow engine can process sub-tasks serially and/or in parallel based on inputs to and results from other sub-tasks.

Performance of sub-tasks (e.g., micro tasks) for an overall task can be automated as appropriate based on machine learning from prior performance of the task and/or prior performance related tasks. Sub-tasks (e.g., micro tasks) that are not automatable can be escalated to micro workers (e.g., less skilled workers, crowd-sourced unskilled workers, etc.). When a micro worker performs a sub-task (e.g., a micro task), results from performance of the sub-task can be used as feedback to train the machine learning.

When a micro worker is unable to perform a sub-task (e.g., a micro task), the overall task can be escalated to a macro worker (e.g., a trained worker, a worker with improved language skills, a worker with cultural knowledge) etc. The macro worker can perform the overall task. For example, when scheduling a meeting, a macro work can identify meeting participants, a desired meeting time, duration, location, and subject. The macro worker can mail to any meeting participant or send a meeting invitation. When a sub-task (e.g., micro task) is waiting for human input, the macro task worker can make the sub-task as pending and go on to other sub-tasks.

The sub-task can be monitored and the macro task can be reactivated when there is more work to be done. Sub-tasks can be restarted when they have waited too long. A macro worker can send a reminder that a response is requested.

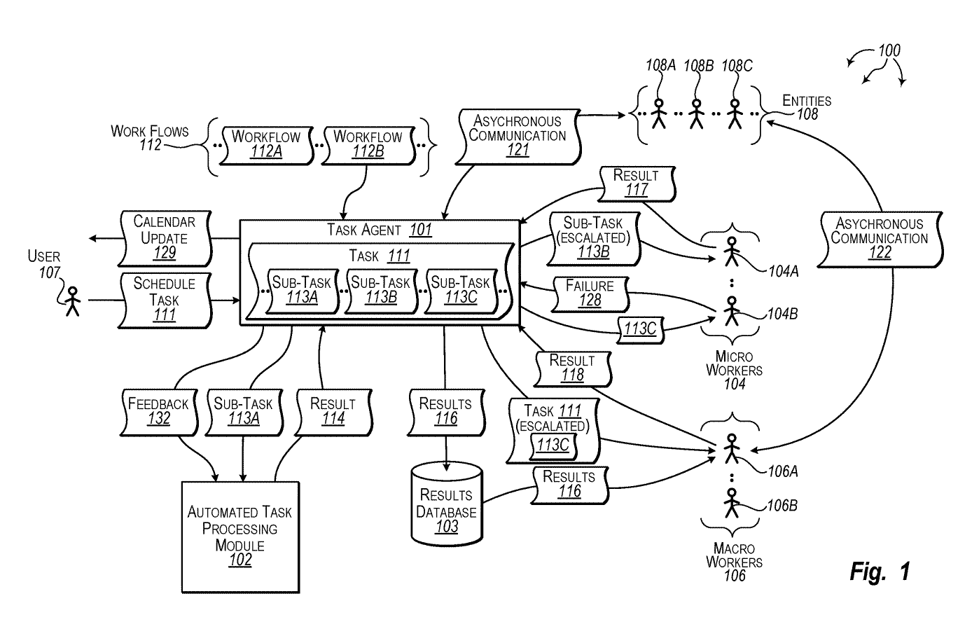

FIG. 1 illustrates an example computer architecture 100 that facilitates automated task processing with escalation. Referring to FIG. 1, computer architecture 100 includes task agent 101, automated task processing module 102, results database 103, micro workers 105, macro workers 106, user 107 and entities 108. Task agent 101, automated task processing module 102, results database 103, micro workers 105, macro workers 106, user 107 and entities 108 can be connected to (or be part of) a network, such as, for example, a Local Area Network (“LAN”), a Wide Area Network (“WAN”), and even the Internet. Accordingly, task agent 101, automated task processing module 102, results database 103, micro workers 105, macro workers 106, user 107 and entities 108, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

As depicted, micro workers 104 includes micro works 104A, 104B, etc. Micro workers 104 can be human workers physically located in one or more different geographic locations. In general, micro workers 104 are able to handle less complex tasks (e.g., sub-tasks). Micro workers 104 can be less skilled workers, crowd-sourced unskilled workers, etc.

Macro workers 106 includes macro workers 106A, 106B, etc. Macro workers 106 can be human workers physically located in one or more different geographic locations and located at the same or different geographic locations than any of micro workers 104. In general, macro workers 104 are able to handle more complex tasks (e.g., overall scheduling tasks). Macro workers 106 can be trained workers, workers with improved language skills, workers with cultural knowledge, etc.

Workflows 112 includes workflows 112A, 112B, etc. Each of workflows 112 defines a plurality of sub-tasks to be completed to perform a task. That is, a workflow breaks down an overall task into a plurality of (less complex) sub-tasks, which when completed completes the overall task. Sub-tasks can include routing sub-tasks, get attendees sub-tasks, get duration sub-tasks, get subject sub-tasks, get location sub-tasks, get phone sub-tasks, get meeting times sub-tasks, get response times sub-tasks, etc. Tasks can include scheduling tasks (meetings, events, etc.), travel requests, expense reports, requisitions, etc.

In general, task agent 101 (e.g., a scheduling agent) is configured to assist with completing tasks for user 107 (and possibly one or more other users). In response to receiving a task, task agent 101 can access a workflow from workflows 112 that corresponds to the task.

For each sub-task define in a workflow, task agent 101 can determine if automated task processing module 102 has the capability to automate performance of the sub-task. When automated task processing module 102 has the capability to automate a sub-task, task agent 101 can send the sub-task to automated task processing module 102. Automated task processing module 102 can perform the sub-task (without human intervention). Automated task processing module 102 can return results of performing the sub-task back to task agent 101.

On the other hand, when automated task processing module 102 lacks the capability to automate a sub-task, task agent 101 can automatically escalate the sub-task to a micro worker 104. The micro worker can perform the sub-task and results of performing the sub-task can be returned back to task agent 101.

Automated task processing module 102 can include machine learning components that learn how to handle sub-tasks through feedback from other modules. For example, task agent 101 can use results from micro worker performance of sub-tasks as feedback to train automated task processing module 101. Accordingly, automated processing of sub-tasks can increase over time as automated task processing module 101 is trained to handle additional sub-tasks.

Results from sub-task processing (both automated and micro worker) can be stored in results database 103. During sub-task performance (either automated or micro worker), a sub-task may refer to results from previously performed sub-tasks stored in results database 103. The sub-task can use stored results to make progress in completing.

When a micro worker lacks the capability to perform a sub-task (or cannot perform a sub-task for some other reason), task agent 101 can automatically escalate a task (i.e., an overall task) to a macro worker. To escalate a task to a macro worker, results from performed sub-tasks along with any remaining unperformed sub-tasks can be sent to the macro worker. The macro worker can use results from performed sub-tasks to complete remaining unperformed sub-tasks. Completion of remaining unperformed sub-tasks in turn completes the (overall) task.

Task and sub-task completion can be based on asynchronous communication with one or more entities. For example, when scheduling a meeting, task and sub-task completion can be based on asynchronous communicate with requested meeting participants. Asynchronous communication can include electronic communication, such as, for example, electronic mail, text messaging, etc. For example, a worker can send an electronic mail message requesting that a person attend a meeting. The worker then waits for a response from the person. The worker can send reminder emails if a response is not received within a specified time period.

A workflow can define relationships between sub-tasks such that some sub-tasks are performed serially and others in parallel. Thus, within a workflow, sub-tasks can be performed in serial and/or in parallel. Some sub-tasks can depend on results from other sub-tasks. These sub-tasks can be performed serially so that results can be propagated. Further sub-tasks may not depend on one another. These further sub-tasks can be performed in parallel.

For example, a sub-task can depend on results from a plurality of other sub-tasks. Thus, the plurality of sub-tasks can be performed in parallel. However, the sub-task is performed after each of the plurality of other sub-tasks completes. In another example, a plurality of sub-tasks depends on results from a sub-task. Thus, the plurality of sub-tasks is performed after the sub-task completes. Different combinations of sub-task pluralities can also depend on another.

The completion of a task can be reflected in user data, such as, for example, in a user's calendar data, requisition date, expense report data, etc.

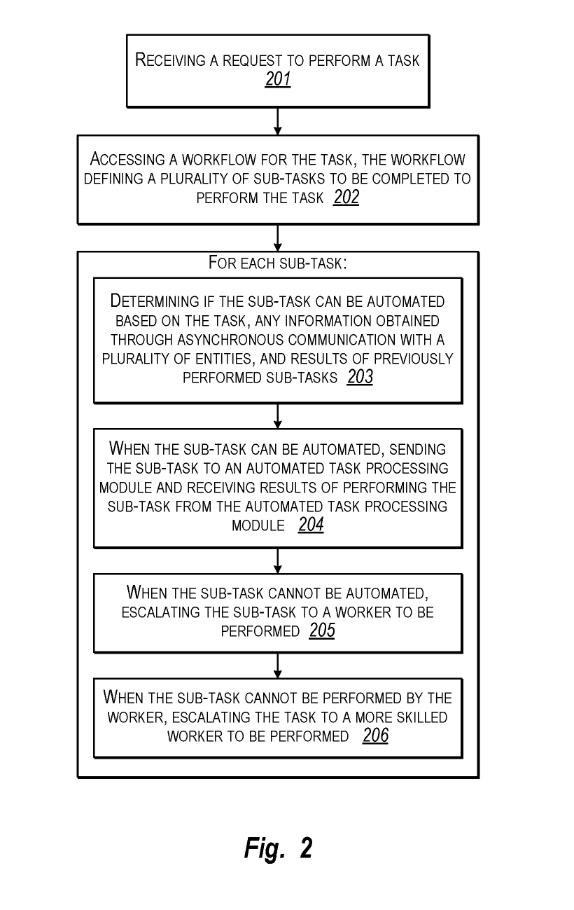

FIG. 2 illustrates a flow chart of an example method for automated task processing with escalation. Method 200 will be described with respect to the components and data of computer architecture 100.

Method 200 includes receiving a request to perform the task (201). For example, task agent 101 can receive scheduling task 111 from user 107. Scheduling task 111 can be a task for scheduling a meeting between user 107 and entities 108. The request can include a time and location and can identify entities 108A, 108B, 108C, etc.

Method 200 includes accessing a workflow for the task, the workflow defining a plurality of sub-tasks to be completed to perform the task (202). For example, task agent 101 can access workflow 112B (a workflow for scheduling meetings). Workflow 112B defines sub-tasks 113A, 113, 113C, etc. for scheduling task 111.

For each sub-task, method 200 includes determining if performance of the sub-task can be automated based on the task, any information obtained through asynchronous communication with the one or more entities, and results of previously performed sub-tasks (203). For example, task agent 101 can determine if automated task processing module 102 has capabilities to automate each of sub-tasks 113A, 113B, 113C, etc. For each sub-task, the determination can be based on scheduling task 111, asynchronous communication with one or more of entities 108A, 108B, 108C, etc., and results (e.g., stored in results database 103) of previously performed sub-tasks.

For each sub-task, when the sub-task can be automated, method 200 includes sending the sub-task to an automated task processing module and receiving results of performing the sub-task from the task processing module (204). For example, task agent 101 can determine that automated task processing module 102 has capabilities to automate sub-task 113A based on task 111, communication from one or more of entities 108A, 108B, 108C, etc., and results stored in results database 103. As such, task agent 101 can send sub-task 113A to automated task processing module 102.

Automated task processing module 102 can perform sub-task 113A and return results 114 to task agent 101. Results 114 can be stored in results database 103

Other automatable sub-tasks can be performed in a similar manner.

For each sub-task, when the sub-task cannot be automated, escalating the sub-task to a worker to be performed (205). For example, task agent 101 can determine that automated task processing module 102 lacks capabilities to automate sub-task 113B based on task 111, communication from one or more of entities 108A, 108B, 108C, etc., and results stored in results database 103. As such, task agent 101 can escalate sub-task 113B to micro worker 104A. Micro worker 104A performs sub-task 113B and returns results 117 to task agent 101. Results 117 can be stored in results database 103.

Task agent 101 can also use result 117 to formulate feedback 132. Task agent 101 can send feedback 132 to automated task processing module 102 as training data. Automated task processing module 102 can used feedback 132 to train machine learning components. For example, feedback 132 can train machine learning components so that processing future instances of sub-task 113B (and/or or similar sub-tasks) can be automated.

Task agent 101 can also determine that automated task processing module 102 lacks capabilities to automate sub-task 113C based on task 111, communication from one or more of entities 108A, 108B, 108C, etc., and results stored in results database 103. As such, task agent 101 can escalate sub-task 113C to micro worker 104B. However, micro worker 104B may be unable to complete sub-task 113B (e.g., due to lack of training, language skills, or other reasons). Micro worker 104B can return failure 128 to task agent 101 indicating an inability to process sub-task 113C.

For each sub-task, when the sub-task cannot be performed by the worker, escalating the task to a more skilled worker to be performed (206). For example, when sub-task 113B cannot be performed by micro worker 104B, task agent 101 can escalate task 111 to macro worker 106A. Any remaining unperformed sub-tasks and results from previously performed sub-tasks can be sent to macro worker 106A. For example, results 116 (i.e., the collective results from automated and micro worker performed sub-tasks, including results 114 and 117) and sub-task 113C (as well as other unperformed sub-tasks defined in workflow 112B) can be sent to macro worker 106A. Macro worker 106B can complete performance of task 111. Results 118 from completing task 111 can be sent back to task agent 101. Task agent 101 can use results 118 to update data for user 107, such as, for example, with calendar update 129.

Completing task 111 can include asynchronous communication 121 and/or asynchronous communication 122. Task agent 101 can use asynchronous communication 121 to obtain information from entities 108 for sub-task completion by automated task processing module 102 and/or micro workers 104. In other aspects, automated task processing module 102 and/or micro workers 104 can conduct asynchronous communication with entities 108 (alternately or in addition to asynchronous communication 121).

Macro worker 106A can use asynchronous communication 122 to obtain information from entities 108 to complete task 111.

In one aspect, a system includes a processor, system memory, storage resources, and a task agent. The task agent, using the processor, is configured to asynchronously communicate with each of a plurality of entities to perform a task (e.g., a scheduling task) for the plurality of entities.

The task agent uses the processor to receive a request to perform the task. The task agent uses the processor to access a workflow for the task, the workflow defining a plurality of sub-tasks to be completed to perform the task.

For each sub-task, the task agent uses the processor to determining if the sub-task can be automated. The determination is based on the scheduling task, any information obtained through asynchronous communication with the plurality of entities, and results of previously performed sub-tasks. For each sub-task, when the sub-task can be automated, the task agent uses the processor to send the sub-task to an automated task processing module and receive results of performing the sub-task from the automated task processing module.

For each sub-task, when the sub-task cannot be automated, the task agent uses the processor to escalate the sub-task to a worker to be performed. For each sub-task, when the sub-task cannot be performed by the worker, the task agent uses the processor to escalate the task to a more skilled worker to be performed.

The task agent can be a scheduling agent used to process scheduling tasks.

In another aspect, a method for asynchronously communicating with each of a plurality of entities to perform a task (e.g., a scheduling task) for the plurality of entities is performed. A request to perform the task is received. A workflow for the task is accessed. The workflow defines a plurality of sub-tasks to be completed to perform the task.

For each sub-task it is determined if the sub-task can be automated. The determination is based on the scheduling task, any information obtained through asynchronous communication with the plurality of entities, and results of previously performed sub-tasks. For each sub-task, when the sub-task can be automated, the sub-task is sent to an automated task processing module and results of performing the sub-task received from the automated task processing module. For each sub-task, when the sub-task cannot be automated, the sub-task is escalated to a (e.g., micro) worker to be performed. For each sub-task, when the sub-task cannot be performed by the worker, the task is escalated to a more skilled worker (e.g., a macro worker) to be performed.

In a further aspect, a computer program product for use at a computer system includes one or more computer storage devices having stored thereon computer-executable instructions that, in response to execution at a processor, cause the computer system to implement a method for asynchronously communicating with each of a plurality of entities to perform a task (e.g., a scheduling task) for the plurality of entities.

The computer program product includes computer-executable instructions that, in response to execution at a processor, cause the computer system to receive a request to perform the task. The computer program product includes computer-executable instructions that, in response to execution at a processor, cause the computer system to access a workflow for the task. The workflow defines a plurality of sub-tasks to be completed to perform the task.

For each sub-task, the computer program product includes computer-executable instructions that, in response to execution at a processor, cause the computer system to determine if the sub-task can be automated based on the scheduling task, any information obtained through asynchronous communication with the plurality of entities, and results of previously performed sub-tasks. For each sub-task, the computer program product includes computer-executable instructions that, in response to execution at a processor, cause the computer system to, when the sub-task can be automated, send the sub-task to an automated task processing module and receiving results of performing the sub-task from the automated task processing module.

For each sub-task, the computer program product includes computer-executable instructions that, in response to execution at a processor, cause the computer system to, when the sub-task cannot be automated, escalate the sub-task to a worker to be performed. For each sub-task, the computer program product includes computer-executable instructions that, in response to execution at a processor, cause the computer system to, when the sub-task cannot be performed by the worker, escalate the task to a more skilled worker to be performed.

Thus, the workload of macro workers is reduced by automated performance of sub-tasks and performance of sub-tasks by micro workers. As machine learning increases, workload of micro workers is also reduced by automated performance of sub-tasks. Accordingly, a three tiered approach of automation, micro workers, and macro workers is scalable and cost efficient while also providing flexibility to accurately handle more complex tasks and sub-tasks.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A system, the system comprising:
one or more processors;
system memory coupled to one or more processors, the system memory storing instructions that are executable by the processor; and
the one or more processors executing the instructions stored in the system memory to asynchronously communicate with each of a plurality of entities to perform a scheduling task for the plurality of entities, including the following:
receive a request to perform the scheduling task;
access a workflow for the scheduling task from the system memory, the workflow defining a plurality of sub-tasks to be completed to perform the scheduling task;
for each sub-task:
determine if the sub-task can be automated based on the scheduling task, any information obtained through asynchronous communication with the plurality of entities, and results of previously performed sub-tasks;
when the sub-task can be automated, send the sub-task to an automated task processing module via network communication and receiving results of performing the sub-task from the automated task processing module via network communication;
when the sub-task cannot be automated, escalate the sub-task to a worker to be performed; and
when the sub-task cannot be performed by the worker, escalate the scheduling task to a more skilled worker to be performed.

2. The system of claim 1, wherein executing the instructions to escalate the scheduling task to a more skilled worker to be performed comprises executing the instructions to:
access results from any previously performed sub-tasks from a database, the previously performed sub-tasks from among the plurality sub-tasks; and
send the accessed results to the more skilled worker.

3. The system of claim 2, further comprising executing the instructions to receive results indicating completion of the scheduling task by the more skilled worker.

4. The system of claim 1, further comprising executing the instructions to:
receive results indicating completion of the escalated sub-task by the worker; and
use the results as feedback to improve the automated performance of sub-tasks on subsequent attempts to perform the scheduling task.

5. The system of claim 1, wherein executing the instructions to receive a request to perform the scheduling task comprises executing the instructions to receive a request to schedule a meeting for the plurality of entities; and
wherein the plurality of sub-tasks includes sending electronic communication to each of the plurality of entities.

6. The system of claim 1, wherein executing the instructions to escalate the scheduling task to a more skilled worker to be performed comprises executing the instructions to escalate any unperformed sub-tasks to the more skilled worker.

7. The system of claim 1, wherein executing the instructions to receive a request to perform the scheduling task comprises executing the instructions to receive a scheduling task that was delegated from a human user to an automated assistant.

8. A processor implemented method for use at a computer system, the processor implemented method for asynchronously communicating with each of a plurality of entities to perform a scheduling task for the plurality of entities, the processor implemented method comprising:
receiving a request to perform the scheduling task;
accessing a workflow for the scheduling task, the workflow defining a plurality of sub-tasks to be completed to perform the scheduling task;
for each sub-task:
determining if the sub-task can be automated based on the scheduling task, any information obtained through asynchronous communication with the plurality of entities, and results of previously performed sub-tasks;
when the sub-task can be automated, sending the sub-task to an automated task processing module and receiving results of performing the sub-task from the automated task processing module;
when the sub-task cannot be automated, escalating the sub-task to a worker to be performed; and
when the sub-task cannot be performed by the worker, escalating the scheduling task to a more skilled worker to be performed.

9. The method of claim 8, wherein escalating the scheduling task to a more skilled worker to be performed comprises:
accessing results from any previously performed sub-tasks from a database, the previously performed sub-tasks from among the plurality of sub-tasks; and
sending the accessed results to the more skilled worker.

10. The method of claim 8, further comprising receiving results indicating completion of the scheduling task by the more skilled worker.

11. The method of claim 8, further comprising:
receiving results indicating completion of the escalated sub-task by the worker; and
using the results as feedback to improve the automated performance of sub-tasks on subsequent attempts to perform the scheduling task.

12. The method of claim 8, wherein receiving a request to perform the scheduling task comprises receiving a request to schedule a meeting for the plurality of entities; and
wherein the plurality of sub-tasks includes sending electronic communication to each of the plurality of entities.

13. The method of claim 8, wherein escalating the scheduling task to a more skilled worker to be performed comprises escalating any unperformed sub-tasks to the more skilled worker.

14. The method of claim 8, wherein receiving a request to perform the scheduling task comprises receiving a scheduling task that was delegated from a human user to an automated assistant.

15. A processor implemented method for use at a computer system, the processor implemented method for asynchronously communicating with one or more entities to perform a task for the one or more entities, the processor implemented method comprising:
receiving a request to perform the task;
accessing a workflow for the task, the workflow defining a plurality of sub-tasks to be completed to perform the task;
for each sub-task:
determining if performance of the sub-task can be automated based on the task, any information obtained through asynchronous communication with the one or more entities, and results of previously performed sub-tasks;
when the sub-task can be automated, sending the sub-task to an automated task processing module and receiving results of performing the sub-task from the task processing module;
when the sub-task cannot be automated, escalating the sub-task to a worker to be performed; and
when the sub-task cannot be performed by the worker, escalating the task to a more skilled worker to be performed.

16. The method of claim 15, further comprising receiving results indicating completion of the task by automated performance of one or more sub-tasks at the task processing module.

17. The method of claim 15, further comprising receiving results indicating completion of the task by performance of one or more sub-tasks by one or more workers.

18. The method of claim 15, wherein receiving a request to perform the task comprises receiving a request to schedule a meeting.

19. The method of claim 15, further comprising when the sub-task cannot be automated:
receiving results indicating completion of the escalated sub-task by the worker; and
using the results as feedback to improve performance of the automated task processing module on subsequent attempts to perform the sub-task.

20. The method of claim 15, wherein escalating the task to a more skilled worker to be performed comprises escalating any unperformed sub-tasks to the more skilled worker; and
further comprising receiving results indicating completion of the task by the more skilled worker.
